(19) United States
(12) Patent Application Publication
(10) Pub. No.: US 2020/0065987 A1
(43) Pub. Date: Feb. 27, 2020

(54) SIGNAL PROCESSING APPARATUS, MOVING BODY, AND STEREO CAMERA

(71) Applicant: CANON KABUSHIKI KAISHA, Tokyo (JP)

(72) Inventors: Shingo Hikosaka, Kawasaki-shi (JP); Tomoya Onishi, Ayase-shi (JP)

(21) Appl. No.: 16/667,509

(22) Filed: Oct. 29, 2019

Related U.S. Application Data
(63) Continuation of application No. PCT/JP2018/016917, filed on Apr. 26, 2018.

(30) Foreign Application Priority Data
May 2, 2017 (JP) 2017-091873

(51) Int. Cl. G06T 7/593; H04N 13/243; G01C 3/08

(52) U.S. Cl. CPC G06T 7/596; H04N 13/243; G06T 2207/30252; G06T 2207/10012; G01C 3/085

(57) ABSTRACT

Parallax information in a first direction is obtained from a first imaging device and a second imaging device. Parallax information in a second direction differing from the first direction is obtained from a first photoelectric conversion portion included in the first imaging device and a second photoelectric conversion portion included in the first imaging device. Distance information on a distance to an object is obtained from the parallax information in the first direction and the parallax information in the second direction.

### CROSS-REFERENCE TO RELATED APPLICATIONS

This application is a Continuation of International Patent Application No. PCT/JP2018/016917, filed Apr. 26, 2018, which claims the benefit of Japanese Patent Application No. 2017-091873, filed May 2, 2017, both of which are hereby incorporated by reference herein in their entirety.

### TECHNICAL FIELD

The present invention relates to a signal processing apparatus configured to obtain a distance on the basis of parallax; a moving body; and a stereo camera.

### BACKGROUND ART

There is a stereo camera configured to measure a distance to an object, by using the idea of triangulation, from parallax of images obtained from two cameras. In addition, there is proposed a driving support system configured to use measurement information obtained by a stereo camera to generate a warning to a driver, control a handle and a brake, and assure a distance from a leading vehicle. Such a driving support system is required to obtain a distance with high accuracy regardless of a type of an object.

Usually, a stereo camera includes two cameras disposed in a direction horizontal to a road surface and calculates, from parallax of these cameras, a distance to an object. In this case, the parallax is present in the direction horizontal to the road surface, and parallax in a direction perpendicular to the road surface is not obtained. In other words, distance measurement is not possible for an object parallel to a straight line (optical axis) on which the cameras are aligned. For example, a case in which two cameras are disposed in a direction horizontal to a road surface is considered. In a case in which an object parallel to the road surface is imaged, when an edge portion of the object in a horizontal direction is not obtainable, images that are obtainable by a first camera and a second camera are identical to each other. Thus, parallax is not obtainable from the two cameras, and it is not possible to calculate a distance to the object.

To address this problem, a stereo camera described in Japanese Patent Laid-Open No. 10-302048 includes two cameras disposed such that optical axes thereof are substantially parallel to each other and such that the optical axes of the two cameras each have a predetermined set angle with respect to a road surface. In other words, the two cameras are disposed at different heights to configure such that parallax in a direction perpendicular to a road surface is obtained in addition to parallax in a direction horizontal to the road surface. Consequently, according to the configuration described in Japanese Patent Laid-Open No. 10-302048, it is possible to measure a distance to an object that is horizontal to a road surface.

According to the configuration described in Japanese Patent Laid-Open No. 10-302048, however, there is a problem that parallax is not obtained for an object that is horizontal to a plane formed by the optical axes of the two cameras, and it is not possible to measure a distance to the object when an angle formed by the object and a road surface is a predetermined angle.

Then, the present invention provides a signal processing apparatus that enables distance measurement of an object that is horizontal to a plane formed by optical axes of two cameras; a moving body; and a stereo camera.

### SUMMARY OF INVENTION

A signal processing apparatus according to the present invention includes: a first parallax obtaining unit configured to obtain parallax information in a first direction from a first imaging device and a second imaging device; a second parallax obtaining unit configured to obtain parallax information in a second direction differing from the first direction from a first photoelectric conversion portion and a second photoelectric conversion portion included in the first imaging device; and a distance obtaining unit configured to obtain information on a distance to an object from the parallax information in the first direction and the parallax information in the second direction.

Further features of the present invention will become apparent from the following description of exemplary embodiments with reference to the attached drawings.

### BRIEF DESCRIPTION OF DRAWINGS

FIG. 1A is a block diagram of a signal processing apparatus according to a first embodiment.

FIG. 1B is a block diagram of the signal processing apparatus according to the first embodiment.

FIG. 2A is a block diagram of a signal processing apparatus according to a second embodiment.

FIG. 2B is a block diagram of the signal processing apparatus according to the second embodiment.

FIG. 2C is a block diagram of the signal processing apparatus according to the second embodiment.

FIG. 3A is a pixel arrangement plan of an imaging element according to the second embodiment.

FIG. 3B is a pixel arrangement plan of the imaging element according to the second embodiment.

FIG. 4A is a pixel arrangement plan of the imaging element according to the second embodiment.

FIG. 4B is a pixel arrangement plan of the imaging element according to the second embodiment.

FIG. 5A is a pixel arrangement plan of the imaging element according to the second embodiment.

FIG. 5B is a pixel arrangement plan of the imaging element according to the second embodiment.

FIG. 6 is a flow of processing of a signal processing apparatus according to a third embodiment.

FIG. 7 is an illustration of an effect of the signal processing apparatus according to the third embodiment.

FIG. 8 is an illustration of an effect of a signal processing apparatus according to a fourth embodiment.

FIG. 9 is a comparative example of the signal processing apparatus according to the fourth embodiment.

FIG. 10 is an illustration of a driving method of the signal processing apparatus according to the fourth embodiment.

### DESCRIPTION OF EMBODIMENTS

### First Embodiment

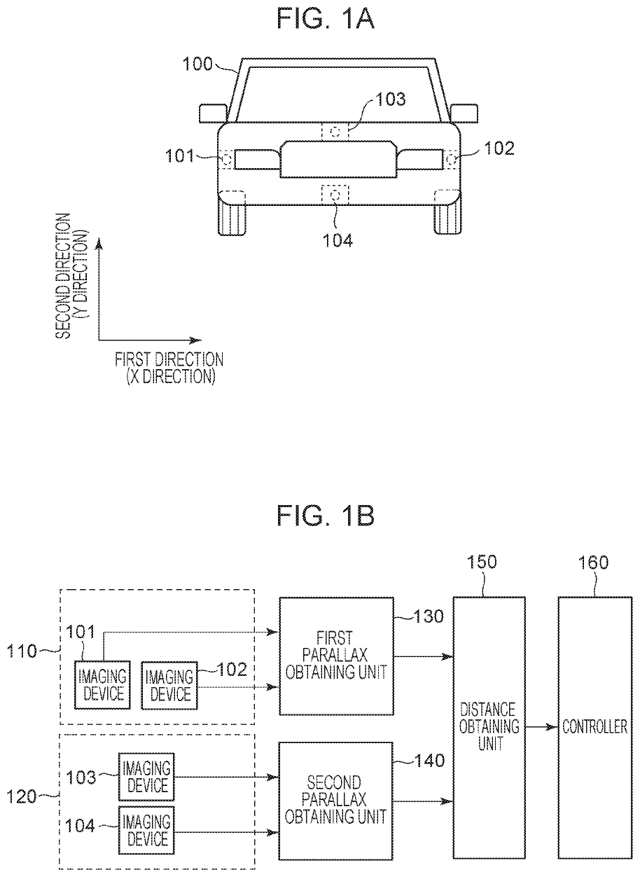

With reference to FIG. 1, a signal processing apparatus according to a first embodiment will be described. FIG. 1A illustrates an automotive vehicle 100 that includes imaging devices 101, 102, 103, and 104. As illustrated in FIG. 1A, the four imaging devices are disposed at upper, lower, left, and right portions, as viewed from the front of the automotive vehicle 100.

FIG. 1B is a block diagram of the first embodiment. The imaging device 101 (first imaging device) and the imaging device 102 (second imaging device) constitute a first stereo camera 110. The imaging device 103 (third imaging device) and the imaging device 104 (fourth imaging device) constitute a second stereo camera 120.

A first parallax obtaining unit 130 obtains parallax information in a first direction on the basis of images that are imaged by the imaging device 101 and the imaging device 102. For example, as illustrated in FIG. 1A, the first direction is a direction (X direction) horizontal to a road surface.

Similarly, a second parallax obtaining unit 140 obtains parallax information in a second direction on the basis of images that are imaged by the imaging device 103 and the imaging device 104. For example, as illustrated in FIG. 1A, the second direction is a direction (Y direction) perpendicular to a road surface. The first direction and the second direction, however, may be any directions provided that the first direction and the second direction are different directions. In other words, the first direction and the second direction do not necessarily perpendicularly intersect with each other provided that the first direction and the second direction intersect with each other.

A distance obtaining unit 150 uses the principle of triangulation and obtains information on a distance to an object, from the parallax information in the first direction obtained by the first parallax obtaining unit 130 and the parallax information in the second direction obtained by the second parallax obtaining unit 140. The distance obtaining unit 150 may be realized by a field programmable gate array (FPGA), an application specific integrated circuit (ASIC), or the like. The distance obtaining unit 150 may be realized by a combination of the FPGA and the ASIC.

The imaging device 101 and the imaging device 102 are not necessarily configured to obtain all information required for image formation provided that the imaging device 101 and the imaging device 102 are configured to obtain information on a pixel number required for obtaining distance obtaining information.

A controller 160 has a function of controlling the automotive vehicle 100. For example, the controller 160 may have a collision determination function that determines a possibility of collision on the basis of an obtained distance and may control, on the basis of a determination result of the collision determination, an alarm to generate a warning to a driver. Alternatively, the controller 160 may give a warning to a user by displaying warning information on a screen of a car navigation system or the like or by applying vibrations to a seatbelt or a steering. When the possibility of collision is high, the controller 160 may perform control that avoids collision and reduces damage by, for example, putting on a brake, returning an accelerator, or suppressing an engine output. The controller 160 can perform, for example, control of automatically driving by following other vehicles, control of automatically driving within a traffic lane, and control of stopping in accordance with information on a stop line. The controller 160 is also applicable to control of a following vehicle via a network. For example, it is also possible to display warning information with respect to a rear vehicle when a distance from a front vehicle to a stop line is reduced, by transmitting information to the rear vehicle.

According to the first embodiment, distance information is obtainable on the basis of the parallax information in the first direction and the parallax information in the second direction differing from the first direction, and it is thus possible to provide a signal processing apparatus that enables distance measurement of an object that is horizontal to a plane formed by optical axes of two cameras.

FIG. 1A illustrates an example in which the imaging devices 101 to 104 are disposed at a front body of a vehicle. This arrangement is employed so that a distance from each of the imaging devices to an object is substantially constant. The arrangement form of the imaging devices is, however, not limited thereto; the imaging devices 101 and 102 may be disposed at left and right side mirrors. In this case, although a distance from an object to the imaging device 101 or 102 differs from a distance from the object to the imaging device 103 or 104, a distance to the object can be obtained by using algorithm of distance correction in the distance obtaining unit 150.

In FIG. 1A, a distance between the imaging devices 101 and 102 is larger than a distance between the imaging devices 103 and 104, and a base line length in the first direction is thus larger than a base line length in the second direction. Therefore, from the point of view of triangulation, accuracy of a distance obtained from the parallax information in the second direction is less than accuracy of a distance obtained from the parallax information in the first direction. Thus, the controller 160 is configured to control the automotive vehicle 100 on the basis of a distance based on the parallax information in the first direction when a difference more than a predetermined threshold is generated between a value of a distance based on the parallax information in the first direction and a value of a distance based on the parallax information in the second direction.

The first embodiment is applicable not only to an automotive vehicle but also, for example, to other moving bodies (moving apparatuses), such as marine vessels, airplanes, or industrial robots.

### Second Embodiment

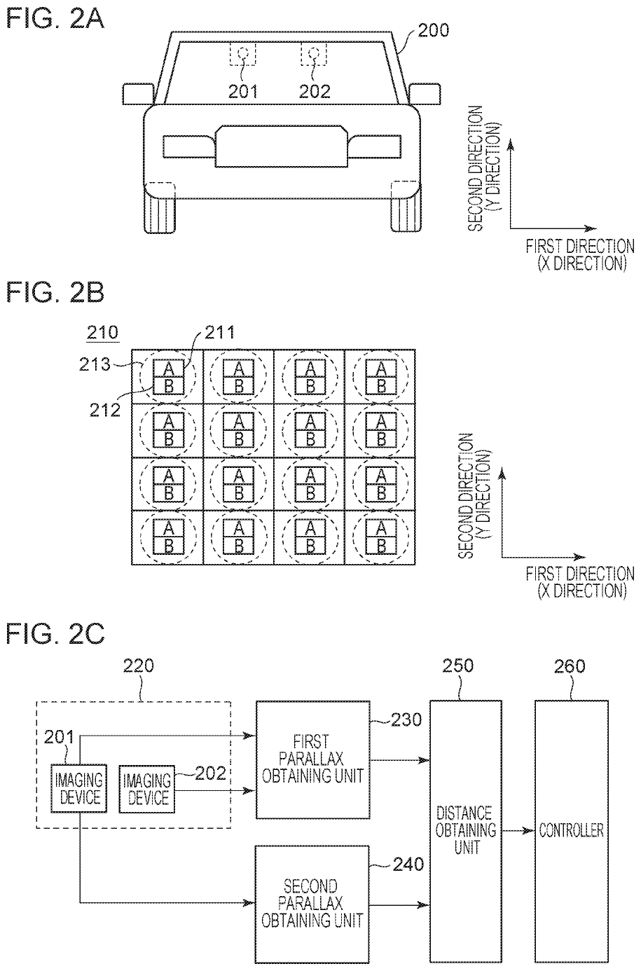

With reference to FIGS. 2A, 2B, and 2C to FIGS. 4A and 4B, a signal processing apparatus according to a second embodiment will be described. The first embodiment is a signal processing apparatus that obtains distance information from two stereo cameras. In contrast, the second embodiment differs from the first embodiment in terms of being a signal processing apparatus configured to obtain distance information from one stereo camera and two photoelectric conversion portions disposed at imaging devices constituting the stereo camera.

FIG. 2A illustrates an automotive vehicle 200 that includes an imaging device 201 (first imaging device) and an imaging device 202 (second imaging device). As illustrated in FIG. 2A, the imaging devices 201 and 202 are disposed at left and right with respect to the front of the automotive vehicle 200.

FIG. 2B is a schematic view of an imaging element 210 included in the imaging device 201. At an imaging region of the imaging element 210, a plurality of pixels are two-dimensionally disposed. In FIG. 2B, a total of 16 pixels in four lines and four rows are illustrated as an exemplification. At each pixel, a photoelectric conversion portion 211 (first photoelectric conversion portion) marked with ‘A’ and a photoelectric conversion portion 212 (second photoelectric conversion portion) marked with ‘B’ are disposed adjacent to each other in the second direction (Y direction). The photoelectric conversion portions 211 and 212 are configured by, for example, PN junction and serve as portions that generate electrical charge as a result of light being incident thereon. The photoelectric conversion portion 211 and the photoelectric conversion portion 212 are provided with one common micro lens. The reference 213 indicates a schematically illustrated outer edge of the micro lens. In FIG. 2B, micro lenses disposed at respective pixels are away from each other with a predetermined gap therebetween; the micro lenses, however, may be disposed in an opposite side direction or a long side direction of the pixels without a gap therebetween. While not illustrated in FIG. 2B, a transfer transistor, an amplification transistor, a reset transistor, and a selective transistor are disposed at each pixel. These transistors may be disposed in common between two or more pixels.

The pixels provided with the photoelectric conversion portion 211 and the photoelectric conversion portion 212 each output a signal for parallax detection and a signal for imaging. A signal based on an electrical charge generated at the photoelectric conversion portion 211 is referred to as an A signal, a signal based on an electrical charge generated at the photoelectric conversion portion 212 is referred to as a B signal, and a signal based on an electrical charge generated at the photoelectric conversion portions 211 and 212 is referred to as an A+B signal. The A+B signal serves as the signal for imaging, and the parallax information in the second direction (Y direction) can be obtained by comparing the A signal and the B signal with each other. Regarding a method of obtaining the signals, the A signal and the B signal may be individually obtained, or the B signal may be obtained by subtracting the A signal from the A+B signal.

FIG. 2C is a block diagram of the second embodiment. Similarly to the first embodiment, the imaging device 201 and the imaging device 202 constitute a first stereo camera 220. A first parallax obtaining unit 230 obtains parallax information in the first direction (X direction) from the imaging devices 201 and 202. A second parallax obtaining unit 240 obtains parallax information in the second direction (Y direction) from the photoelectric conversion portions 211 and 212 included in the imaging device 201.

A distance obtaining unit 250 uses the principle of triangulation and obtains information on a distance to an object from parallax information in the first direction obtained by the first parallax obtaining unit 230 and parallax information in the second direction obtained by the second parallax obtaining unit 240.

A controller 260 has a function of controlling the automotive vehicle 200 and, for example, determines a possibility of collision and gives a warning or the like to a driver.

According to the second embodiment, distance information is obtainable on the basis of parallax information in the first direction and parallax information in the second direction differing from the first direction, and it is thus possible to provide a signal processing apparatus that enables distance measurement of an object that is horizontal to a plane formed by optical axes of two cameras.

It is described above that the imaging element of the imaging device 201 is provided with the photoelectric conversion portion 211 and the photoelectric conversion portion 212. However, the imaging device 202 may also include an imaging element similar to that of the imaging device 201. In this case, the second parallax obtaining unit 240 can obtain, not only parallax information in the second direction from the imaging device 201, but also parallax information in the second direction from the imaging device 202.

Although it is described above that, mainly, the first direction is an in-plane direction of a road surface, and the second direction is a direction perpendicular to the in-plane direction of the road surface, the first direction and the second direction may be directions opposite thereto. In this case, the imaging devices 201 and 202 disposed in a transverse direction in FIG. 2A may be changed to be disposed in a longitudinal direction, and the photoelectric conversion portions 211 and 212 disposed in the longitudinal direction in FIG. 2B may be changed to be disposed in the transverse direction.

It is described above that the parallax information is obtained from the signal based on the electrical charge generated at the photoelectric conversion portions 211 and 212 of the same pixel. The parallax information, however, may be obtained using a signal based on an electrical charge generated at the photoelectric conversion portion 211 of a first pixel and a signal based on an electrical charge generated at the photoelectric conversion portion 212 of a second pixel differing to the first pixel.

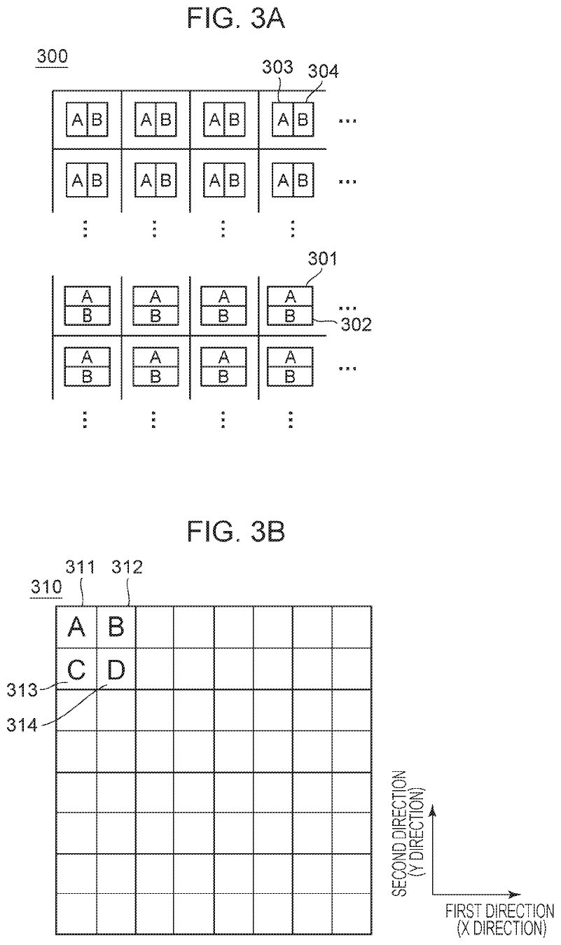

FIG. 3A illustrates a pixel configuration in a form that differs from that in FIG. 2B. To simplify the description, outer edges of micro lenses are not illustrated in FIG. 3A. In FIG. 3A, photoelectric conversion portions 301 and 302 correspond to the photoelectric conversion portions 211 and 212, respectively, and parallax information in the second direction is obtained by the photoelectric conversion portions 301 and 302. In addition, it is also possible to obtain parallax information in the first direction from photoelectric conversion portions 303 and 304 illustrated in FIG. 3A. The first parallax obtaining unit 230 that has obtained the parallax information in the first direction outputs the information to the distance obtaining unit 250. Considering the length of the base line length, accuracy of a distance based on parallax information in the first direction obtained from the imaging device 201 and the imaging device 202 is higher than accuracy of a distance based on parallax information in the first direction obtained from the photoelectric conversion portion 303 and the photoelectric conversion portion 304. However, when one of the imaging devices constituting the stereo camera is disabled for some reasons, it is not possible to use the imaging devices as a stereo camera that obtains a distance to an object. Even in this case, when the photoelectric conversion portions 301, 302, 303, and 304 are mounted on the imaging element of the imaging device 201 or the imaging device 202, there is an advantage that it is possible to obtain also parallax information in the first direction.

An imaging element 310 illustrated in FIG. 3B shows a configuration in which four photoelectric conversion portions are disposed at one pixel. Parallax information in the first direction is obtainable from photoelectric conversion portions 311 and 312. Similarly, parallax information in the first direction is obtainable from photoelectric conversion portions 313 and 314. Parallax information in the second direction is obtainable from the photoelectric conversion portions 311 and 313. Similarly, parallax information in the second direction is obtainable from the photoelectric conversion portions 312 and 314. According to the configuration illustrated in FIG. 3B, there is an advantage that, even when one of the imaging devices constituting a stereo camera is disabled, parallax information in the first direction is obtainable.

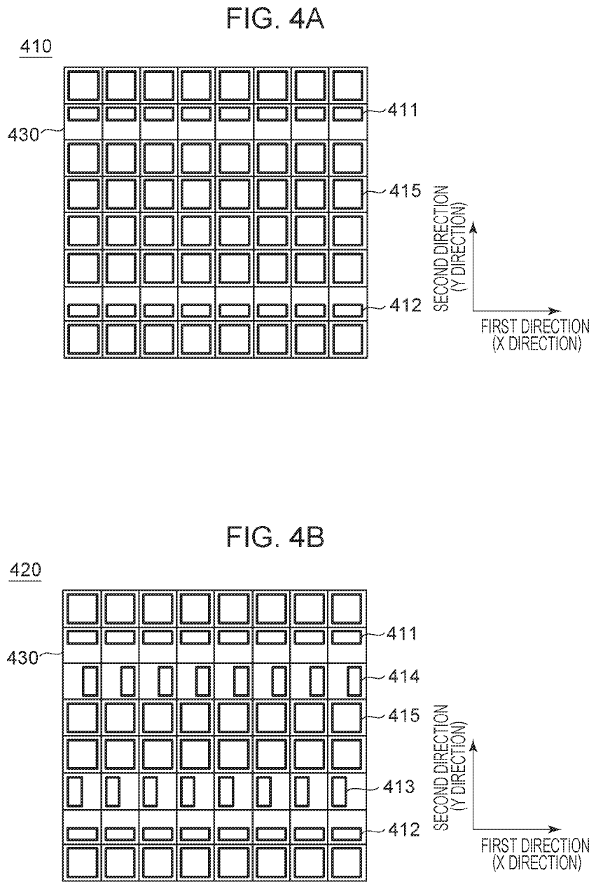

Each of FIGS. 4A and 4B illustrates a configuration in which pixels for imaging and pixels for parallax detection are served by different pixels. In an imaging element 410 illustrated in FIG. 4A, the references 411, 412, and 415 indicate openings of a light shielding portion 430 disposed at an upper portion of a photoelectric conversion portion (not illustrated). Pixels (first pixels) corresponding to a portion of the light shielding portion having the openings 411 and pixels (second pixels) corresponding to a portion of the light shielding portion having the openings 412 are the pixels for parallax detection. Pixels (third pixels) corresponding to a portion of the light shielding portion having the openings 415 are the pixels for imaging. In plan view, the openings 411 and the openings 412 are disposed to be eccentric to the center of the photoelectric conversion portion, and part of incident light is shielded by the light shielding portion. For example, in FIG. 4A, the openings 411 and 412 are disposed to be eccentric in the second direction. The A signal is obtainable from the pixels including the portion of the light shielding portion having the openings 411. The B signal is obtainable from the pixels including the portion of the light shielding portion having the openings 412. Parallax information in the second direction can be obtained by comparing these signals with each other. The light shielding portion 430 having the openings is constituted by a wiring pattern disposed at any of a plurality of wiring layers. For example, the light shielding portion 430 is constituted by a wiring pattern of a first layer. According to the configuration illustrated in FIG. 4A, distance information can be obtained on the basis of parallax information in the first direction and parallax information in the second direction, and it is thus possible to provide a signal processing apparatus that enables distance measurement of an object that is horizontal to a plane formed by optical axes of two cameras.

FIG. 4B illustrates a form additionally having openings that are eccentric in a different direction from FIG. 4A. In an imaging element 420 illustrated in FIG. 4B, the references 413 and 414 indicate openings of the light shielding portion disposed to be eccentric in the first direction to the center of the photoelectric conversion portion. Parallax information in the first direction is obtainable from pixels including portions of the light shielding portion having the openings 413 and the openings 414. In other words, according to the form illustrated in FIG. 4B, when one of the imaging devices constituting the first stereo camera is disabled, it is possible to obtain a distance to an object from parallax information in the first direction.

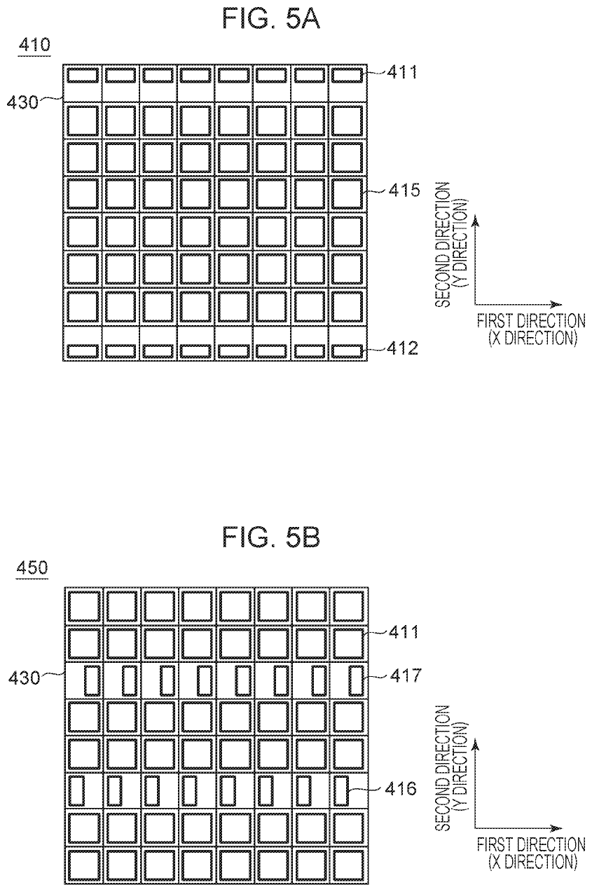

FIG. 5A illustrates the imaging element 410 included in the imaging device 201 (first imaging device). FIG. 5B illustrates a form of an imaging element 450 included in the imaging device 202 (second imaging device). FIG. 5A illustrates the light shielding portion 430 having the openings 411 and 412 that are eccentric in the second direction. FIG. 5B illustrates the light shielding portion 430 having openings 416 and 417 that are eccentric in the first direction. In general, pixels having eccentric openings are not usable as pixels for imaging, and it is thus required to interpolate information from pixels having eccentric openings by using information of pixels for imaging adjacent to the pixels having the eccentric openings. In contrast, according to the forms illustrated in FIGS. 5A and 5B, pixel lines of the imaging device 201 where the pixels having the eccentric openings are disposed and pixels lines of the imaging device 202 where the pixels having the eccentric openings are disposed are different pixel lines. Thus, for example, information obtained from the first line in FIG. 5B is usable for the pixels at the first line provided with the openings 411. In other words, to interpolate information lacking in the imaging device 201, information obtained by the imaging device 202 is usable. In FIGS. 5A and 5B, the directions of the eccentric openings differ between the imaging device 201 and the imaging device 202. The directions of the eccentric openings, however, may be identical to each other.

In the above description, the first direction is the in-plane direction of a road surface, and the second direction is a direction perpendicular to the in-plane direction of the road surface. The first direction and the second direction, however, may be directions opposite thereto.

### Third Embodiment

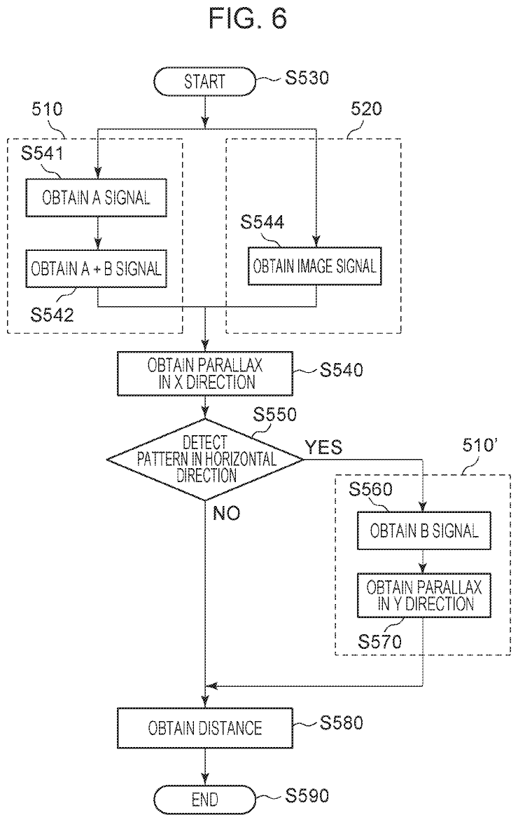

With reference to FIG. 6, a flow of processing of a signal processing apparatus according to a third embodiment will be described. The third embodiment addresses a reduction in a processing time by reducing a computation for obtaining of parallax and a distance, by obtaining parallax and a distance in the second direction (Y direction), as necessary.

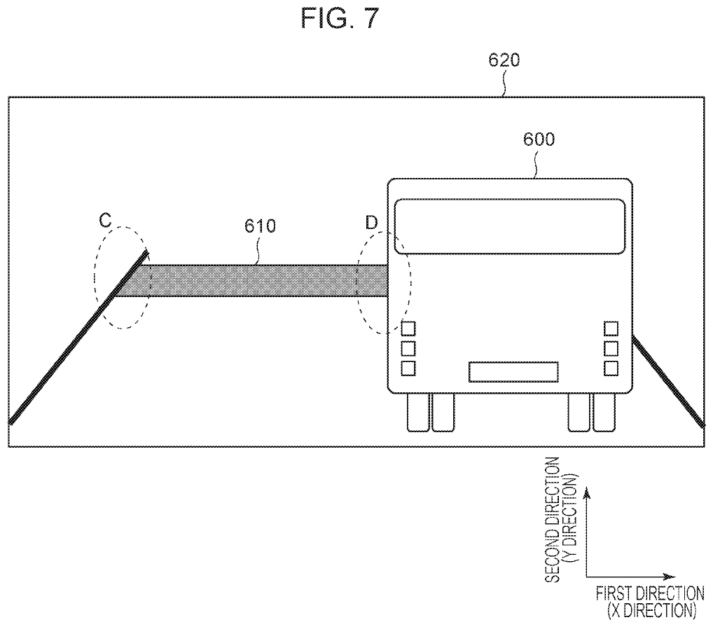

There are, mainly, two types of patterns that require parallax in the second direction (Y direction) in addition to the first direction (X direction). One is a case in which parallax in the first direction is not obtained when an edge portion is not detected due to an object being outside a frame. The other is a case in which parallax information is not uniquely determined for one object. FIG. 7 illustrates a screen 620 at which images from imaging devices included in an automotive vehicle are indicated. An automotive vehicle 600 stopped at the front is indicated on the right side of the screen 620. In the screen 620, an edge of a left end portion of a stop line 610 is recognizable (refer to the dashed line C). Meanwhile, an edge of a right end portion of the stop line 610 is concealed by the automotive vehicle 600 (refer to the dashed line D). Therefore, when parallax of the stop line 610 in the first direction (X direction) is obtained, the edge of the right end portion of the stop line 610 is an edge formed by a boarder with the automotive vehicle 600, and distance information obtained therefrom is thus a distance to the automotive vehicle 600. Meanwhile, from the edge of the left end portion of the stop line, parallax information of the stop line is obtained, and thus, distance information to the stop line is obtained. In such a case, two pieces of distance information are present for one object, and it is not possible to determine correct distance information from the parallax in the first direction.

FIG. 6 illustrates a flow of processing using the signal processing apparatus according to the second embodiment. In FIG. 6, the references 510 and 510′ correspond to processing steps in the imaging device 201 (first imaging device) according to the second embodiment. The reference 520 corresponds to a processing step in the imaging device 202 (second imaging device) according to the second embodiment.

First, at the imaging device 201 (first imaging device), when processing is started (S530), the A signal is obtained from the photoelectric conversion portion 211, and the A+B signal is obtained from the photoelectric conversion portions 211 and 212 (S541, S542). At the imaging device 202 (second imaging device), an image signal is obtained (S544) from a signal of the photoelectric conversion portion.

Next, parallax in the first direction (X direction) is obtained from the A+B signal obtained in S542 and the image signal obtained in S544.

Next, by using the signals obtained from the imaging device 201 and the imaging device 202, a shape of a stop line, which is a pattern parallel to the first direction (X direction), for example, a pattern in a horizontal direction, is detected (S550). As a result of detecting the shape of the stop line, when it is determined that correct distance information is not obtainable from only the parallax in the first direction, the A signal is subtracted from the A+B signal, and the B signal, which is a signal from the photoelectric conversion portion 212, is obtained (S560). Then, parallax in the second direction (Y direction) is obtained (S570) from the A signal and the B signal to obtain a distance to an object, and the processing is ended (S580, S590).

When the shape of the stop line, which is a pattern in the horizontal direction, is not detected, the distance to the object is obtained without obtaining the B signal and the like, and the processing is ended (S580, S590).

In other words, the signal processing apparatus according to the third embodiment has a configuration that switches between a first mode in which both the parallax in the first direction and the parallax in the second direction are obtained and a second mode in which only the parallax in the first direction is obtained without obtaining the parallax in the second direction. Consequently, it is possible to reduce steps of obtaining the B signal, obtaining the parallax in the second direction, obtaining the distance in the second direction, and the like, which reduces a time required from when imaging is performed with the stereo camera until distance information is output. As a result, a time lag between imaging an object with the imaging devices and controlling the automotive vehicle is reduced, which enables controlling of the automotive vehicle to be performed in real time more accurately.

In the above, mainly, the case in which parallax information is not uniquely determined for one object has been described. The third embodiment is, however, also applicable to a case in which an edge portion is not detected due to an object being outside a frame. In this case, in the blocks of S540 and S550, the process may be such that whether parallax in the first direction (X direction) is obtainable is determined, and, when the parallax in the first direction is obtainable, the B signal and the like are not obtained. The aforementioned advantage is also provided by this configuration.

### Fourth Embodiment

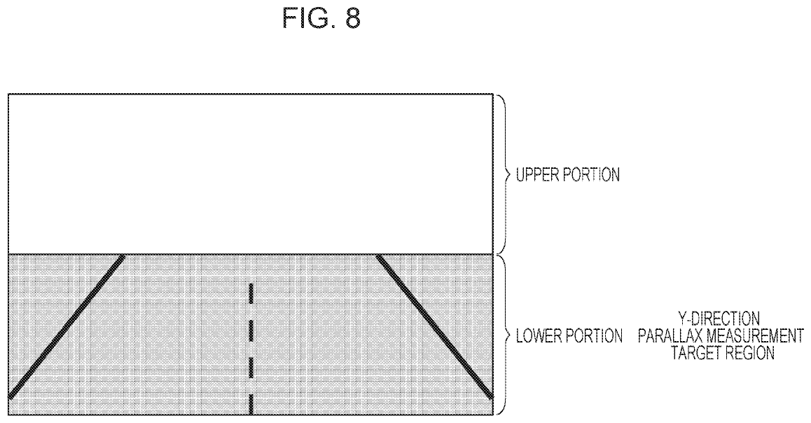

With reference to FIG. 8 to FIG. 10, a signal processing apparatus according to a fourth embodiment will be described.

FIG. 8 illustrates an example of an image imaged by the imaging devices. The lower portion of the image includes many objects (for example, a stop line) that require obtaining parallax in the Y direction, compared with the upper portion of the image. Thus, in the fourth embodiment, the A+B signal and the A signal that serve as signals for measuring a phase difference of image surfaces are output at the lower portion of the image, and the upper portion of the image outputs only the A+B signal. Consequently, it is possible to reduce a reading time required for outputting one frame and increase a frame rate.

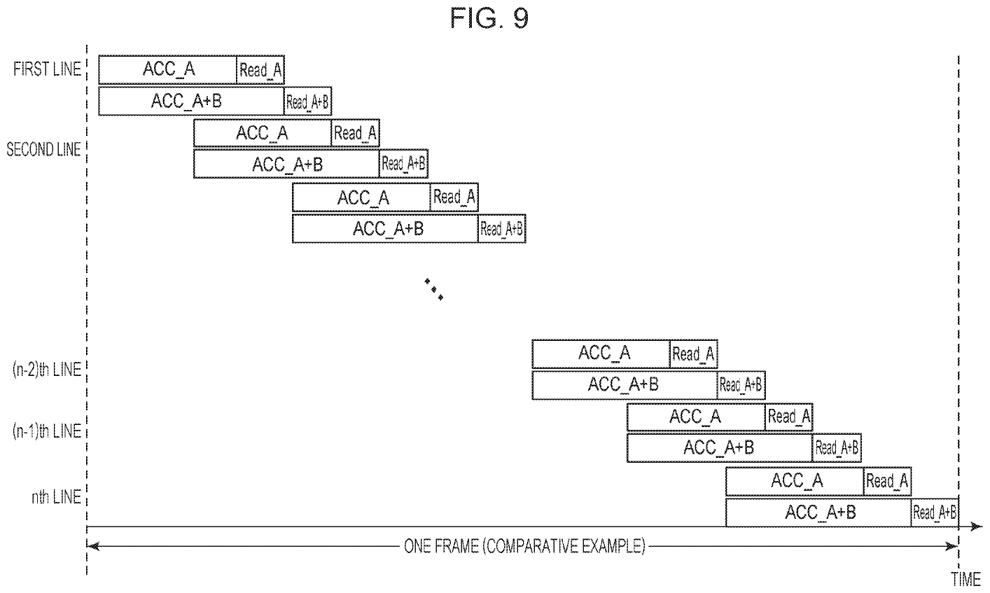

FIG. 9 is a comparative example of the fourth embodiment and schematically illustrates operation of an imaging element when a signal for measuring a phase difference of image surfaces is output at an entire region of the imaging element. In an imaging region at which a plurality of pixels are two-dimensionally disposed, accumulation (ACC) and reading (Read) are performed at pixels at each line. In FIG. 9, ACC_A denotes an electrical-charge accumulation period for the A signal, ACC_A+B denotes an electrical-charge accumulation period for the A+B signal, Read_A denotes a reading period of the A signal, and Read_B denotes a reading period of the B signal.

In FIG. 9, the start of the block of ACC_A is, for example, the timing when a transfer transistor (first transfer transistor) that is for the photoelectric conversion portion 211 and that has been turned on is turned off after being set at a reset level. The end of the block of ACC_A is, for example, the timing when the first transfer transistor that has been turned on for transferring an electrical charge is turned off. The end of the block of Read_A is, for example, the timing when the A signal is stored in a storage capacitor of a peripheral circuit region.

In FIG. 9, the start of the block of ACC_A+B is, for example, the timing when a transfer transistor (second transfer transistor) that is for the photoelectric conversion portion 212 and that has been turned on is turned off after being set at a reset level. The end of ACC_A+B is, for example, the timing when the second transfer transistor that has been turned on for transferring an electrical charge is turned off. The end of the block of Read_A+B is, for example, the timing when the A+B signal is stored in a storage capacitor of a peripheral circuit region. The first transfer transistor may be turned on/off for electrical charge transfer from the photoelectric conversion portion 211 at the timing when the second transfer transistor is turned on/off for electrical charge transfer from the photoelectric conversion portion 212. Such an operation enables the electrical-charge accumulation periods of the photoelectric conversion portions 211 and 212 to be similar to each other when the A+B signal is generated.

As illustrated in FIG. 9, the comparative example requires a predetermined time to read one frame because the A signal and the A+B signal are read for the all lines.

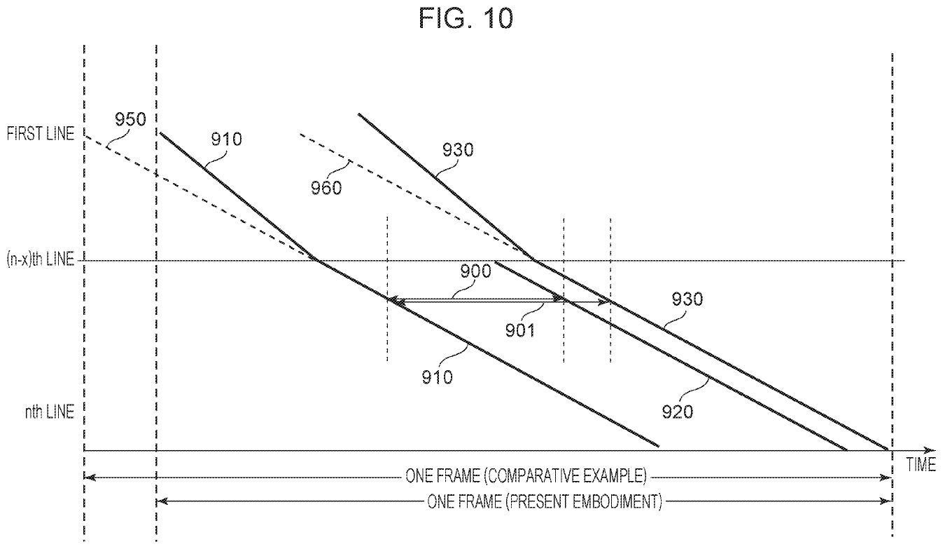

FIG. 10 schematically illustrates operation of an imaging element according to the fourth embodiment. The (n-x)th line to the nth line constituting the lower portion of a screen perform the same operation as that of the comparative example illustrated in FIG. 9. FIG. 10 is changed from FIG. 9 in terms of indication method, and thus, correspondence between FIG. 9 and FIG. 10 will be described below.

Regarding the (n-x)th line to the nth line in FIG. 10, a reset scanning line 910 indicates the timing of the start of the blocks of ACC_A and ACC_A+B in FIG. 9, that is, the timing when accumulation at the photoelectric conversion portions 211 and 212 is started. A read scanning line 920 in FIG. 10 indicates the timing when the block of Read_A in FIG. 9 is ended. Similarly, a read scanning line 930 in FIG. 10 indicates the timing when the block of Read_A+B in FIG. 9 is ended. The reference 900 in FIG. 10 indicates, regarding the A signal, a period from the start of the electrical-charge accumulation period to the end of reading. The reference 901 indicates, regarding the A+B signal, a period from the start of the electrical-charge accumulation period to the end of reading.

As illustrated in FIG. 10, regarding the first line to the (n-x)th line constituting the upper portion of the screen, the A signal is not read and only the A+B signal is read. The fourth embodiment is not required to perform Read_A, which enables a reduction in a scanning time. A reset scanning line 950 indicates the timing when the block of Read_A+B in the fourth embodiment is ended. The reset scanning line 950 indicated by a dashed line indicates the timing of the start of the block of ACC_A+B in the comparative example, and a read scanning line 960 indicates the timing when the block of Read_A+B in the comparative example is ended. Thus, according to the fourth embodiment, it is possible to reduce the scanning time more than the comparative example, and it is possible to reduce the time per frame.

In other words, the signal processing apparatus according to the fourth embodiment is in the first mode, in which parallax in the section direction is not obtained, at a first pixel line group (pixel lines that form the upper portion of an image) in one frame. The signal processing apparatus according to the fourth embodiment is in the second mode, in which parallax in the second direction is obtained, at a second pixel line group (pixel lines that form the lower portion of the image) that differs from the first pixel line group. Consequently, it is possible to reduce the time per frame, which enables vehicle control with improved accuracy.

The first to fourth embodiments have been described above. The present invention is, however, not limited by the aforementioned embodiments and can be variously changed and modified. For example, the processing flow described in the third embodiment may be performed by using the configuration described in the first embodiment. The processing flow described in the third embodiment and the processing flow described in the fourth embodiment may be combined together.

According to the present invention, there are provided a signal processing apparatus that enables distance measurement of an object that is horizontal to a plane formed by optical axes of two cameras; a moving body; and a stereo camera.

The present invention is not limited by the aforementioned embodiments and can be variously changed and modified without deviating from the spirit and the scope of the present invention. Accordingly, to make the scope of the present invention public, the following claims are attached.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A signal processing apparatus comprising:
a first parallax obtaining unit configured to obtain parallax information in a first direction from a first imaging device and a second imaging device;
a second parallax obtaining unit configured to obtain parallax information in a second direction differing from the first direction from a first photoelectric conversion portion and a second photoelectric conversion portion included in the first imaging device; and
a distance obtaining unit configured to obtain distance information on a distance to an object from the parallax information in the first direction and the parallax information in the second direction,
wherein the processing apparatus is configured to be switchable between a first mode in which the parallax information in the second direction is obtained by the second parallax obtaining unit and a second mode in which the parallax information in the second direction is not obtained by the second parallax obtaining unit.

2. The signal processing apparatus according to claim 1,
wherein the parallax information in the first direction is parallax information in an in-plane direction of a road surface on which a moving body moves, and
wherein the parallax information in the second direction is parallax information in a direction intersecting the in-plane direction of the road surface.

3. The signal processing apparatus according to claim 1, wherein the first parallax obtaining unit is configured to obtain the parallax information in the first direction from the first photoelectric conversion portion and the second photoelectric conversion portion included in the first imaging device.

4. The signal processing apparatus according to claim 1,
wherein an imaging element of the first imaging device includes a first pixel line group and a second pixel line group, and
wherein the second parallax obtaining unit is configured to process information from the first pixel line group in the second mode and process information from the second pixel line group in the first mode.

5. The signal processing apparatus according to claim 1,
wherein the first photoelectric conversion portion and the second photoelectric conversion portion are disposed adjacent to each other in the second direction, and
wherein the first photoelectric conversion portion and the second photoelectric conversion portion are provided with a common micro lens.

6. The signal processing apparatus according to claim 5,
wherein the first imaging device or the second imaging device includes a third photoelectric conversion portion and a fourth photoelectric conversion portion disposed adjacent to the third photoelectric conversion portion in the first direction, and
wherein the third photoelectric conversion portion and the fourth photoelectric conversion portion are provided with a common micro lens.

7. The signal processing apparatus according to claim 1, comprising:
a first light shielding portion having a first opening and configured to shield part of light incident on the first photoelectric conversion portion; and
a second light shielding portion having a second opening and configured to shield part of light incident on the second photoelectric conversion portion,
wherein the first opening and the second opening are eccentric in the second direction.

8. The signal processing apparatus according to claim 7,
wherein the first imaging device or the second imaging device includes a third photoelectric conversion portion and a fourth photoelectric conversion portion,
wherein the signal processing apparatus includes
a third light shielding portion having a third opening and configured to shield part of light incident on the third photoelectric conversion portion, and
a fourth light shielding portion having a fourth opening and configured to shield part of light incident on the fourth photoelectric conversion portion, and
wherein the third opening and the fourth opening are eccentric in the first direction.

9. The signal processing apparatus according to claim 8,
wherein the second imaging device includes the third photoelectric conversion portion and the fourth photoelectric conversion portion, and
wherein a pixel line at the first imaging device where the first light shielding portion or the second light shielding portion is disposed and a pixel line at the second imaging device where the third light shielding portion or the fourth light shielding portion is disposed are different pixel lines.

10. A signal processing apparatus comprising:
a first parallax obtaining unit configured to obtain parallax information in a first direction from a first imaging device and a second imaging device;
a second parallax obtaining unit configured to obtain parallax information in a second direction differing from the first direction from a third imaging device and a fourth imaging device;
a distance obtaining unit configured to obtain distance information from the parallax information in the first direction and the parallax information in the second direction; and
a controller configured to control a moving body based on the distance information.

11. A moving body comprising:
the signal processing apparatus according to claim 1,
wherein the moving body is controlled based on the distance information of the signal processing apparatus.

12. A stereo camera comprising:
a first imaging device; and
a second imaging device disposed with respect to the first imaging device in a first direction,
wherein the first imaging device includes a first photoelectric conversion portion and a second photoelectric conversion portion that are provided with respect to a common micro lens, and
wherein the first photoelectric conversion portion and the second photoelectric conversion portion are disposed adjacent to each other in a second direction differing from the first direction.

13. A moving body comprising:
the stereo camera according to claim 12,
wherein the moving body is controlled based on distance information of the stereo camera.
